(19) United States
(12) Patent Application Publication
(10) Pub. No.: US 2019/0272592 A1
(43) Pub. Date: Sep. 5, 2019

(54) SYSTEM AND METHOD TO IMPLEMENT ENDPOINT COLLATERALIZED FINANCIAL INSTRUMENT

(71) Applicant: Sean Woodward, Atlanta, GA (US)

(72) Inventor: Sean Woodward, Atlanta, GA (US)

(21) Appl. No.: 16/418,766

(22) Filed: May 21, 2019

Related U.S. Application Data
(63) Continuation of application No. 14/986,178, filed on Dec. 31, 2015, now abandoned.

(51) Int. Cl. G06Q 40/02; H04L 29/06; H04L 29/08

(52) U.S. Cl. CPC G06Q 40/025; H04L 67/10; H04L 67/42

(57) ABSTRACT

Aspects direct to systems and methods for implementing an endpoint collateralized financial instrument. A borrower may use an endpoint device to send a request to a server for a loan or credit product. Upon receiving the request, the server determines whether the endpoint device is subject to an approval for the endpoint collateralized financial instrument. When the endpoint device is approved, the server further determines an amount of money, and issues a notification to the endpoint device via the network to indicate the approval and the amount of money. Thus, the borrower may choose to borrow the amount of money for the loan using the endpoint device as the collateral, and the server sends the amount of money as a loan to the borrower. The borrower retains a right to use the endpoint device under a condition. The server may disable the endpoint device when the borrower violates the condition.

### CROSS-REFERENCE TO RELATED PATENT APPLICATION

This application claims priority to and the benefit of, pursuant to 35 U.S.C. § 119(e), U.S. provisional patent application Ser. No. 62/124,743, filed Dec. 31, 2014, entitled “ENDPOINT COLLATERALIZED FINANCIAL INSTRUMENT,” by Sean Woodward, the disclosure of which is incorporated herein in its entirety by reference.

### FIELD OF THE INVENTION

The present invention relates generally to an endpoint collateralized financial instrument and particularly to computerized systems and methods to implement, utilize and remotely manage an endpoint collateralized financial instrument.

### BACKGROUND OF THE INVENTION

A financial instrument is a tradable asset of any kind, which may be cash, evidence of an ownership interest in an entity, or a contractual right to receive or deliver cash or another financial instrument. According to the definition of the International Accounting Standards (IAS) 32 and 39, a financial instrument is defined as “any contract that gives rise to a financial asset of one entity and a financial liability or equity instrument of another entity.” With the rapid development of Internet and related computer network technology, however, there is no existing mechanism to implement a web-based financial instrument.

Therefore, a heretofore unaddressed need exists in the art to address the aforementioned deficiencies and inadequacies.

### SUMMARY OF THE INVENTION

In one aspect, the present invention relates to a system for implementing an endpoint collateralized financial instrument. In certain embodiments, the system includes a computing device functioning as a server, comprising a processor and a storage device storing computer executable code, and an endpoint device communicatively connected to the computing device via a network and functioning as an endpoint. The computer executable code, when executed at the processor, is configured to: receive a request from the endpoint device, wherein the request comprises endpoint specific data of the endpoint device and borrower information identifying a user of the endpoint device as a borrower; determine whether the endpoint device is subject to an approval for the endpoint collateralized financial instrument based on the endpoint specific data and the borrower information; when the endpoint device is subject to the approval, determine an amount of money borrowable by the borrower based on the endpoint specific data, and issue a notification to the endpoint device via the network to indicate the approval for the endpoint collateralized financial instrument; in response to receiving a money borrowing instruction from the endpoint device for the amount of money, send the amount of money as a principal of a loan or a credit product to the borrower using the endpoint device as collateral, wherein the borrower retains a right to use the endpoint device under a condition; and disable the endpoint device when the borrower violates the condition. When the endpoint device receives the notification, the borrower is capable of generating the money borrowing instruction at the endpoint device to borrow the amount of money for the loan or the credit product using the endpoint device as the collateral.

In certain embodiments, the endpoint device may be a smartphone, a smartwatch, a tablet, a laptop computer, a desktop computer, a point of sale (POS) terminal, an internet-enabled television, an internet-enabled motor vehicle, or a specialized internet-enabled device.

In certain embodiments, the endpoint specific data includes: manufacturer data of the endpoint device; type of the endpoint device; a present value of the endpoint device; operating system information of the endpoint device; geographic location data of the endpoint device; diagnostic data of the endpoint device; and real-time transaction data specific to sales of the endpoint device.

In certain embodiments, the present value of the endpoint device is a fair market value or a retail price of the endpoint device.

In certain embodiments, the computer executable code, when executed at the processor, is configured to determine whether the endpoint device is subject to the approval based on the type of the endpoint device and the geographic location data of the endpoint device.

In certain embodiments, the computer executable code includes: an endpoint management application, configured to manage the endpoint device; an endpoint transaction analyzer, configured to perform a real-time analysis of the real-time transaction data specific to sales of the endpoint device; and an endpoint valuation system, configured to perform valuation of the endpoint device.

In certain embodiments, the computer executable code, when executed at the processor, is configured to determine whether the endpoint device is subject to the approval based on the real-time transaction data specific to sales of the endpoint device.

In certain embodiments, the endpoint valuation system is configured to perform valuation of the endpoint device by: determining the present value of the endpoint device; determining a past value of the endpoint device as a new device; and determining an estimated future value of the endpoint device as a used or refurbished device.

In certain embodiments, the endpoint valuation system is further configured to perform valuation of the endpoint device by: obtaining perception information of the borrower based on the endpoint specific data and the borrower information; and determining an intrinsic value of the endpoint device based on the perception information and the present value, the past value and the estimated future value of the endpoint device.

In certain embodiments, the computer executable code, when executed at the processor, is configured to determine the amount of money by: evaluating, by the endpoint valuation system, the endpoint device and determining the intrinsic value of the endpoint device; and determining the amount of money based on the intrinsic value of the endpoint device.

In certain embodiments, the computer executable code, when executed at the processor, is further configured to monitor a current location of the endpoint device as the collateral.

In certain embodiments, the condition includes the borrower repaying payments of the loan or the credit product.

In one aspect, the present invention relates to a method for implementing an endpoint collateralized financial instrument. In certain embodiments, the method includes: receiving, at a computing device, a request from an endpoint device communicatively connected to the computing device via a network, wherein the computing device functions as a server and the endpoint device functions as an endpoint, and the request comprises endpoint specific data of the endpoint device and borrower information identifying a user of the endpoint device as a borrower; determining, by the computing device, whether the endpoint device is subject to an approval for the endpoint collateralized financial instrument based on the endpoint specific data and the borrower information; when the endpoint device is subject to the approval, determining, by the computing device, an amount of money borrowable by the borrower based on the endpoint specific data, and issuing a notification to the endpoint device via the network to indicate the approval for the endpoint collateralized financial instrument; in response to receiving a money borrowing instruction from the endpoint device for the amount of money, funding, by the computing device, the amount of money to the borrower as a principal of a loan or a credit product using the endpoint device as collateral, wherein the borrower retains a right to use the endpoint device under a condition; and disabling, by the computing device, the endpoint device when the borrower violates the condition. In certain embodiments, when the endpoint device receives the notification, the borrower is capable of generating the money borrowing instruction at the endpoint device to borrow the amount of money for the loan or the credit product using the endpoint device as the collateral.

In certain embodiments, the amount of money is determined by: evaluating the endpoint device and determining an intrinsic value of the endpoint device; and determining the amount of money based on the intrinsic value of the endpoint device. In certain embodiments, the intrinsic value of the endpoint device is determined by: determining the present value of the endpoint device; determining a past value of the endpoint device as a new device; determining an estimated future value of the endpoint device as a used or refurbished device; obtaining perception information of the borrower based on the endpoint specific data and the borrower information; and determining the intrinsic value of the endpoint device based on the perception information and the present value, the past value and the estimated future value of the endpoint device.

In certain embodiments, the method further includes: monitoring a current location of the endpoint device as the collateral.

A further aspect of the present invention relates to a non-transitory computer readable medium storing computer executable code. In one embodiment, the computer executable code, when executed at a processor of a computing device, is configured to: receive a request from an endpoint device communicatively connected to the computing device via a network, wherein the computing device functions as a server and the endpoint device functions as an endpoint, and the request comprises endpoint specific data of the endpoint device and borrower information identifying a user of the endpoint device as a borrower; determine whether the endpoint device is subject to an approval for the endpoint collateralized financial instrument based on the endpoint specific data and the borrower information; when the endpoint device is subject to the approval, determine an amount of money borrowable by the borrower based on the endpoint specific data, and issuing a notification to the endpoint device via the network to indicate the approval for the endpoint collateralized financial instrument; in response to receiving a money borrowing instruction from the endpoint device for the amount of money, fund the amount of money to the borrower as a principal of a loan or a credit product using the endpoint device as collateral, wherein the borrower retains a right to use the endpoint device under a condition; and disable the endpoint device when the borrower violates the condition. In certain embodiments, when the endpoint device receives the notification, the borrower is capable of generating the money borrowing instruction at the endpoint device to borrow the amount of money for the loan or the credit product using the endpoint device as the collateral.

These and other aspects of the present invention will become apparent from the following description of the preferred embodiment taken in conjunction with the following drawings, although variations and modifications therein may be affected without departing from the spirit and scope of the novel concepts of the disclosure.

### BRIEF DESCRIPTION OF THE DRAWINGS

The accompanying drawings illustrate one or more embodiments of the invention and, together with the written description, serve to explain the principles of the invention. Wherever possible, the same reference numbers are used throughout the drawings to refer to the same or like elements of an embodiment. The following figures are presented for the purpose of illustration only, and are not intended to be limiting.

FIG. 1 schematically shows a system according to certain embodiments of the present invention.

FIG. 2 schematically shows a platform operating server according to certain embodiments of the present invention.

FIG. 3 shows a flowchart of the operation of the system according to certain embodiments of the present invention.

FIGS. 4A to 4G schematically show screenshots of an endpoint device according to certain embodiments of the present invention.

### DETAILED DESCRIPTION OF THE INVENTION

The present invention will now be described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Referring to the drawings, like numbers indicate like components throughout the views. As used in the description herein and throughout the claims that follow, the meaning of “a,” “an,” and “the” includes plural reference unless the context clearly dictates otherwise. Also, as used in the description herein and throughout the claims that follow, the meaning of “in” includes “in” and “on” unless the context clearly dictates otherwise. Moreover, titles or subtitles may be used in the specification for the convenience of a reader, which has no influence on the scope of the invention.

As used herein, the phrase “at least one of A, B, and C” should be construed to mean a logical (A or B or C), using a non-exclusive logical OR. It should be understood that one or more steps within a method may be executed in different order (or concurrently) without altering the principles of the present disclosure.

As used herein, the term “financial instrument” may refer to a tradable asset of any kind, which may be cash, evidence of an ownership interest in an entity, or a contractual right to receive or deliver cash or another financial instrument. According to the definition of the International Accounting Standards (IAS) 32 and 39, a financial instrument is defined as “any contract that gives rise to a financial asset of one entity and a financial liability or equity instrument of another entity.”

As used herein, the term “endpoint” may refer to an internet-capable device on a wireline or wireless network. Examples of the endpoints may include, without being limited to, laptop and desktop computers, mobile devices such as smartphones, smartwatches, tablets, or other specialized hardware such as internet-enabled televisions or internet-enabled motor vehicles.

As used herein, the term “module” may refer to, be part of, or include suitable software components that provide the described functionality. In certain embodiments, the term module may include both software components, such as codes, and hardware components that execute the codes.

The term “code”, as used herein, may include computer software, firmware, and/or microcode, and may refer to programs, routines, functions, classes, and/or objects. The term “shared”, as used herein, means that some or all code from multiple hardware modules may be executed using a single (shared) processor. In addition, some or all code from multiple hardware modules may be stored by a single (shared) memory. The term “group”, as used herein, means that some or all code from a single hardware module may be executed using a group of processors. In addition, some or all code from a single hardware module may be stored using a group of memories.

The terms used in this specification generally have their ordinary meanings in the art, within the context of the invention, and in the specific context where each term is used.

Certain terms that are used to describe the invention are discussed below, or elsewhere in the specification, to provide additional guidance to the practitioner in describing the apparatus and methods of the invention and how to make and use them. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that the same thing can be said in more than one way. Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification, including examples of any terms discussed herein, is illustrative only, and in no way limits the scope and meaning of the invention or of any exemplified term. Likewise, the invention is not limited to various embodiments given in this specification. Furthermore, subtitles may be used to help a reader of the specification to read through the specification, which the usage of subtitles, however, has no influence on the scope of the invention.

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated.

As used herein, the terms “comprising,” “including,” “having,” “containing,” “involving,” and the like are to be understood to be open-ended, i.e., to mean including but not limited to.

In finance, a loan is a debt provided by one entity (organization or individual) to another entity at an interest rate, and evidenced by a note which specifies, among other things, the principal amount, interest rate, and date of repayment. A loan entails the reallocation of the subject asset (or assets) for a period of time, between the lender (the entity providing the loan) and the borrower (the entity receiving the loan). For example, in a loan, the borrower may initially receive or borrow an amount of money, which is referred to as the principal, from the lender. The borrower is thus is obligated to pay back or repay an equal amount of money to the lender at a later time. In addition, the loan is generally provided at a cost, referred to as interest on the debt, which provides an incentive for the lender to engage in the loan. In a legal loan, each of these obligations and restrictions is enforced by a contract, which can also place the borrower under additional restrictions known as loan covenants.

A secured loan is a loan in which the borrower pledges some asset (e.g. a car or property) as collateral for the loan, which then becomes a secured debt owed to the creditor who gives the loan. The debt is thus secured against the collateral. In the event that the borrower defaults, the creditor takes possession of the asset used as collateral and may sell it to regain some or all of the amount originally loaned to the borrower, for example, foreclosure of a home. From the creditor's perspective, this is a category of debt in which a lender has been granted a portion of the bundle of rights to specified property. If the sale of the collateral does not raise enough money to pay off the debt, the creditor can often obtain a deficiency judgment against the borrower for the remaining amount. The opposite of secured debt/loan is unsecured debt, which is not connected to any specific piece of property and instead the creditor may only satisfy the debt against the borrower rather than the borrower's collateral and the borrower. Generally speaking, secured debt may attract lower interest rates than unsecured debt due to the added security for the lender. However, credit history, ability to repay, and expected returns for the lender are also factors affecting rates.

There are various types of secured loans. For example, a mortgage loan is a very common type of debt instrument, used by many individuals to purchase housing. In this arrangement, the money is used to purchase the property. The financial institution, however, is given security—a lien on the title to the house—until the mortgage is paid off in full. If the borrower defaults on the loan, the bank would have the legal right to repossess the house and sell it, to recover sums owing to it.

In some instances, a loan taken out to purchase a new or used car may be secured by the car, in much the same way as a mortgage is secured by housing. The duration of the loan period is considerably shorter—often corresponding to the useful life of the car. There are two types of auto loans, direct and indirect. A direct auto loan is where a bank gives the loan directly to a consumer. An indirect auto loan is where a car dealership acts as an intermediary between the bank or financial institution and the consumer.

There are two purposes for a loan secured by debt. In the first purpose, by extending the loan through securing the debt, the creditor is relieved of most of the financial risks involved because it allows the creditor to take the property in the event that the debt is not properly repaid. In exchange, this permits the second purpose where the debtors may receive loans on more favorable terms than that available for unsecured debt, or to be extended credit under circumstances when credit under terms of unsecured debt would not be extended at all. The creditor may offer a loan with attractive interest rates and repayment periods for the secured debt.

In addition to the secured loan, there are other forms of secured financial instruments. For example, a credit derivative, sometimes also referred to as a credit product, is a financial instrument that transfers credit risk related to an underlying entity or a portfolio of underlying entities from one party to another without transferring the underlying(s). One example of the credit product is a credit card, which allows the cardholder to pay for goods and services based on the holder's promise to pay for them. These credit products may be designed to separate and then transfer the credit risk or the risk of an event of default of a corporate or sovereign borrower, transferring it to an entity other than the lender or debtholder.

Aspects of the present invention relates to systems and methods for implementing an endpoint collateralized financial instrument, which is a credit product secured by an endpoint for a secured loan or other forms of credit products. Specifically, an endpoint device is utilized as the collateral of the secured loan. In certain embodiments, the endpoint device may be any Internet-enabled device on a wireline or wireless network, such as a smartphone, a smartwatch, a tablet, a laptop computer, a desktop computer, or other specialized hardware such as an internet-enabled television or an internet-enabled motor vehicle.

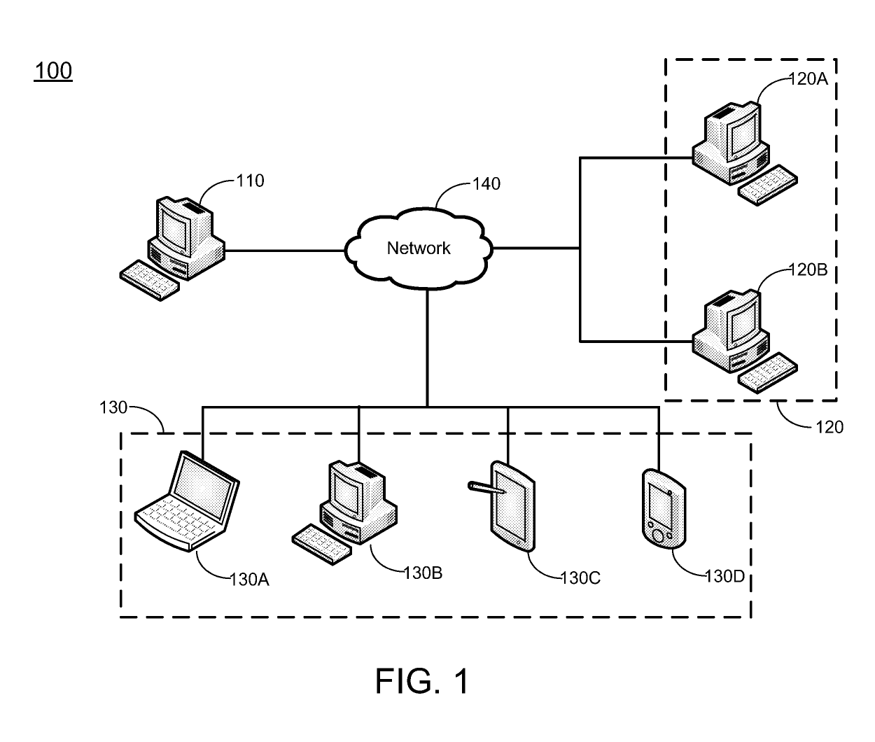

FIG. 1 schematically shows a system according to certain embodiments of the present invention. In certain embodiments, the system 100 may be a client-server network system for implementing endpoint collateralized financial instruments, which include multiple computing devices communicatively interconnected via a network 140. Specifically, at least one computing device 110 of the system 100 may function as a server computer of the system 100, and all the other computing devices 120A, 120B, 130A, 130B, 130C and 130D may each function as a client computers of the system 100. In particular, the client computers may be categorized as two groups, including a group of remote computing devices 120 (which include the computing devices 120A and 120B) that may be operated by lenders, and a group of endpoint devices 130 (which include the computing devices 130A, 130B, 130C and 130D) that may be operated by borrowers. Each of the endpoint devices 130 may function as an endpoint of the system 100. In certain embodiments, each of the computing devices, including the computing device 110, the remote computing devices 120 and the endpoint devices 130, can be implemented by one or more computers, which can be a desktop computer, a laptop computer, a tablet, a mobile device or any other computing systems or devices having computing functionalities and capable of executing the software applications of the system 100 directly or remotely. In certain embodiments, one or more of the computing devices may be implemented by virtual machines. The network 130 may be a wired or wireless network, and may be of various forms such as an Internet, a Local Area Network (LAN), a Wide Area Network (WAN), or a cloud network. In certain embodiments, the system 100 may include multiple networks for performing the interconnection of the computing devices.

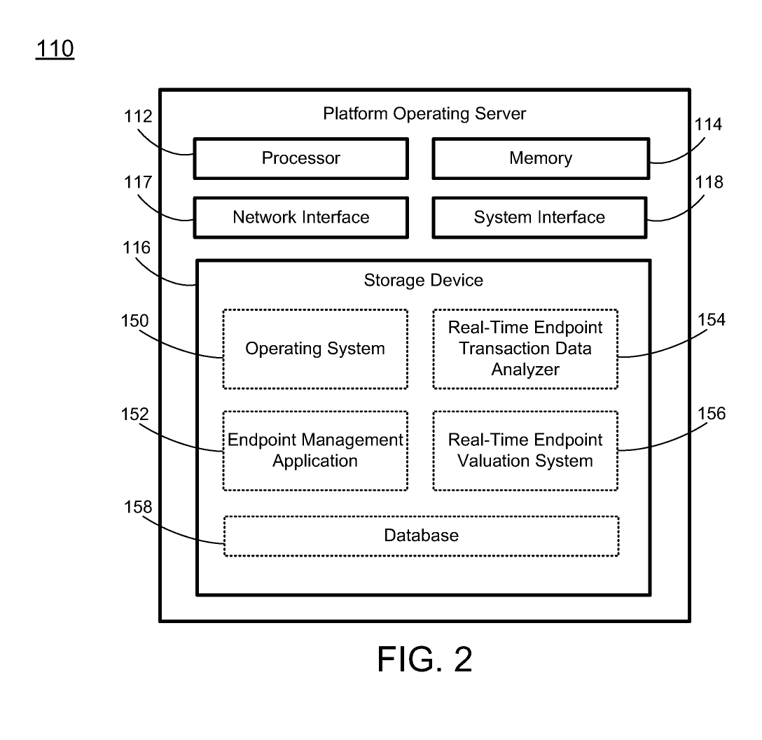

The computing device 110 is a computer system which includes the necessary hardware and software components to function as a platform operating server of the system 100. FIG. 2 schematically shows a platform operating server according to certain embodiments of the present invention. As shown in FIG. 2, the platform operating server 110 includes, among other hardware and software components not shown, a processor 112, a memory 114, and a storage device 116. Further, the platform operating server 110 may include various interfaces, such as a network interface 117 and a system interface 118. In certain embodiments, the system 100 may include one computing device 110 as shown in FIG. 1 to function as the platform operating server of the system 100. Alternatively, the platform operating server of the system 100 may be implemented by multiple computing devices, where the hardware and software components may be distributed among the computing devices to perform the conversion operation of the platform operating server 110.

The processor 112 is a processor which is configured to control operation of the platform operating server 110, and to execute the software applications for the platform operating server 110. In certain embodiments, the platform operating server 110 may run on more than one processor or central processing unit (CPU) as the host processor, such as two CPUs, four CPUs, eight CPUs, or any suitable number of CPUs.

The memory 114 may be a volatile memory, such as the random-access memory (RAM), for storing the data and information during the operation of the platform operating server 110. In certain embodiments, the memory 114 is in communication with the processor 112 through a system bus (not shown).

The storage device 116 may be a non-volatile data storage media for storing software applications of the platform operating server 110. The software applications may be in the form of computer executable code or instructions, which may be executed at the processor 112. Example of the storage device 116 may include hard drives, floppy disks, optical drives, flash memory, memory cards, USB drives, or any other types of data storage devices. In certain embodiments, the platform operating server 110 may include multiple storage devices 116, and each of the storage devices 116 may be a local storage physically located in the platform operating server 110, or an external storage physically located outside the platform operating server 110. For example, the storage device 116 may be a network storage being connected to the platform operating server 110 via the network 140.

As shown in FIG. 1, the software applications stored in the storage device 116 may include: an operating system (OS) 150, an endpoint management application 152, an endpoint transaction data analyzer 154, and an endpoint valuation system 156. Further, a database 158 may also be stored in the storage device 116. In certain embodiments, the storage device 116 may store other software applications of the platform operating server 110. In certain embodiments, some or all of the software applications may be combined to form a package software program or multiple programs. In certain embodiments, some or all of the software applications may be implemented by hardware modules with firmware components, such as a programmable chip storing necessary firmware.

The OS 120 may be collective management software managing the operation of the platform operating server 110. For example, the OS 120 can include a set of functional programs that control and manage operations of the devices connected to the platform operating server 110, such as providing the server function such that the client computers (i.e., the remote computing devices 120 and the endpoint devices 130) may connect to the platform operating server 110 via the network 140. The set of application programs provide certain utility software for the user to manage the platform operating server 110. In certain embodiments, the OS 120 is operable to multitask, i.e., execute computing tasks in multiple threads, and may be operating system of different platforms. For example, the OS 120 may be commercial OS package software systems such as Microsoft Windows, Macintosh OSX, UNIX, LINUX, iOS, Android, etc.

The endpoint management application 152 is a software application to manage the endpoint devices 130 being connected to the platform operating server 110. For example, when a user (i.e., a borrower) of an endpoint device 130 operates the endpoint device 130 to connect to the platform operating server 110, the endpoint device 130 may transmit endpoint specific data that relates to the endpoint device 130 to the platform operating server 110. Upon receiving the endpoint specific data, the endpoint management application 152 may authenticate the endpoint device 130 by comparing and verifying the information of the endpoint specific data with data stored in the database 158. Examples of the endpoint specific data of the endpoint device 130 may include, without being limited to, credential information of the endpoint device 130; manufacturer data of the endpoint device 130; type of the endpoint device 130; a present value (which may be a fair market value or a retail price) of the endpoint device 130; operating system information of the endpoint device 130; geographic location data of the endpoint device 130; diagnostic data of the endpoint device 130; or any other information that may be used to authenticate or recognize the endpoint device 130. In certain embodiments, the endpoint specific data may further include borrower information, such as identity information and/or credential information of the borrower, or other information that may help to determine whether the loan should be granted to the borrower, such as a credit score. Further, the endpoint management application 152 may update the data stored in the database 158 based on the received endpoint specific data of the endpoint device 130. In certain embodiments, when the endpoint management application 152 does not recognize an endpoint device 130 by its endpoint specific data, the endpoint management application 152 may recognize the endpoint device 130 as a new device, and may add information of the endpoint specific data of the endpoint device 130 to the database 158 in order to add the new device to the system 100.

The endpoint transaction data analyzer 154 is a software application to perform a real-time analysis to the transaction data of the endpoint devices 130 being connected to the platform operating server 110. Specifically, the endpoint transaction data analyzer 154 may retrieve and update the data stored in the database 158 related to the transaction data of the endpoint devices 130. In certain embodiments, specifically, the data stored in the database 158 may include, among other information, real-time transaction data specific to sales of the endpoint device 130. In certain embodiments, the endpoint specific data of each endpoint device 130 may also include the real-time transaction data specific to sales of the endpoint device 130. For example, the real-time transaction data specific to sales of the endpoint device 130 may include a present value of the endpoint device 130; a past value of the endpoint device 130 as a new device; or an estimated future value of the endpoint device 130 as a used or refurbished device. It should be particularly noted that the present value of the endpoint device 130 may refer to a fair market value of the endpoint device 130, or may refer to a retail price of the endpoint device 130.

The endpoint valuation system 156 is a software application to perform a real-time valuation of the endpoint devices 130 being connected to the platform operating server 110. For example, the endpoint valuation system 156 may retrieve and update the data stored in the database 158 that may be related to the endpoint specific data of the endpoint devices 130. In certain embodiments, the data stored in the database 158 may include, among other information, a present value (which may be a fair market value or a retail price) of the endpoint device 130. In certain embodiments, the endpoint specific data of each endpoint device 130 may also include the present value (the fair market value or the retail price) of the endpoint device 130. In certain embodiments, the data stored in the database 158 and/or the endpoint specific data of each endpoint device 130 may further include other information that may be used to perform the real-time valuation of the endpoint device 130, such as a past value of the endpoint device 130 as a new device, and/or an estimated future value of the endpoint device 130 as a used or refurbished device.

The database 158 is a database storing all data related to the management of the endpoint devices 130. In certain embodiments, the data stored in the database 158 may include the endpoint specific data received from each of the endpoint devices 130. Examples of the data stored in the database 158 may include, without being limited to, credential information of the endpoint device 130; manufacturer data of the endpoint device 130; type of the endpoint device 130; a present value (which may be a fair market value or a retail price) of the endpoint device 130; operating system information of the endpoint device 130; geographic location data of the endpoint device 130; diagnostic data of the endpoint device 130; real-time transaction data specific to sales of the endpoint device 130; or any other information that may be used to authenticate or recognize the endpoint device 130.

The remote computing devices 120 are computing devices remotely connected to the platform operating server 110 through the network 140. In certain embodiments, each of the remote computing devices 120 includes the necessary hardware and software components to function as a client computer of the system 100, such that the lender may remotely connect to the platform operating server 110 in order to control the management of the endpoint devices 130 and monitor the money lending process. In certain embodiments, each of the remote computing devices 120 may be a thin client or zero client computer. In certain embodiments, each of the remote computing devices 120 may include, among other hardware and software components, a processor, a memory, and a storage device, and details of these components are not hereinafter elaborated.

The endpoint devices 130 are computing devices remotely connected to the platform operating server 110 through the network 140. In certain embodiments, each of the endpoint devices 130 includes the necessary hardware and software components to function as a client computer of the system 100, such that the borrower may remotely connect to the platform operating server 110 in order to borrow money. Examples of the endpoint devices 130 may include, without being limited to, mobile devices such as smartphones, smartwatches and tablets; computing devices such as laptop computers and desktop computers; or other specialized hardware devices such as point of sale (POS) terminals. For example, as shown in FIG. 1, the endpoint devices 130 include a laptop computer 130A, a desktop computer 130B, a tablet 130C and a smartphone 130D. In certain embodiments, any device with computing functionality and network connectivity may function as an endpoint device 130, such as an Internet-enabled television, an Internet-enabled motor vehicle, and/or other specialized Internet-enabled devices.

In certain embodiments, each of the endpoint devices 130 may include, among other hardware and software components, a processor, a memory, and a storage device, and details of these components are not hereinafter elaborated. Further, each of the endpoint devices 130 may include an endpoint application, which provides a user interface (UI) and other necessary mechanisms for the borrower to perform the money borrowing process. In certain embodiments, the endpoint application and/or other software tools or modules of each of the endpoint devices 130 may be pre-installed in the endpoint device 130. In certain embodiments, a copy of the endpoint application may be stored in the platform operating server 110 or any other server being connected to the network 140, such that a borrower may choose to download the endpoint application via the network 140 and install the endpoint application on the endpoint device 130.

In certain embodiments, when the endpoint device 130 is a mobile device, the endpoint application may be a mobile application installed on the mobile device for the implementation of the endpoint collateralized financial instrument. Specifically, a mobile application is a computer program designed to run on smartphones, smartwatches, tablets and other mobile devices, which may be used for general productivity and information retrieval, including but not limited to email, calendar, contacts, and as mobile games, factory automation, order tracking, banking, Global Positioning System (GPS) and location-based services.

In certain embodiments, the endpoint application of each endpoint device 130 may provide an endpoint security management mechanism. Endpoint security management is a policy-based approach to network security that requires the endpoint devices 130 to comply with specific criteria before they are granted access to network resources. In certain embodiments, endpoint security management mechanisms and/or systems work on a client/server model in which a centrally managed server (such as the platform operating server 110) or gateway hosts the security program and an accompanying client program is installed on each endpoint device 130. Endpoint security management systems, which can be software based or use a dedicated appliance, discover, manage and control the endpoint devices 130 that request access to the network 140. In certain embodiments, required elements for the endpoint security management mechanism may include an approved operating system, a virtual private network (VPN) client and anti-virus software with current updates. In certain embodiments, endpoint devices 130 that do not comply with policy can be controlled by the system 100 to varying degrees. For example, the system 100 may remotely lock the device or restrict Internet browsing capabilities.

In certain embodiments, the endpoint devices 130 may comply with a software-as-a-service (SaaS) delivery model. In the SaaS delivery model, the host server (such as the platform operating server 110) and its security programs are maintained remotely by the vendor. In either delivery model, when a client (such as an endpoint device 130) attempts to log onto the network, the server program validates user credentials and scans the device to make sure that it complies with defined security policies, before performing other client/server functionalities and processes.

In certain embodiments, the endpoint management application 152 may perform the issuance of the endpoint collateralized financial instrument to an endpoint device 130. Specifically, when a user of an endpoint device 130 (i.e., a borrower) is in need for a loan, the borrower must pre-install an endpoint application on the endpoint device 130 in order to connect to the platform operating server 110. Thus, the borrower may operate the endpoint application at the endpoint device 130 to send a request to the platform operating server 110. The request may include endpoint specific data of the endpoint device 130 and borrower information identifying the user as a borrower. When the platform operating server 110 receives the request from the endpoint device 130, the endpoint management application 152 may, in response to the request, determine whether the endpoint device 130 is subject to an approval for the endpoint collateralized financial instrument based on the endpoint specific data and the borrower information. For example, the endpoint management application 152 may determine whether the endpoint device is subject to the approval based on the type of the endpoint device and the geographic location data of the endpoint device. In certain embodiments, the endpoint management application 152 may activate the endpoint transaction data analyzer 154 to perform a real-time analysis to the transaction data of the endpoint device 130 in order to determine whether the endpoint device 130 is subject to the approval for the endpoint collateralized financial instrument. When the endpoint management application 152 determines that the endpoint device 130 is subject to the approval, the endpoint management application 152 may determine an amount of money borrowable by the borrower based on the endpoint specific data, and then send a notification to the endpoint device via the network to indicate the approval for the endpoint collateralized financial instrument and the amount of money to be borrowable by the borrower. In certain embodiments, the endpoint management application 152 may activate the endpoint valuation system 156 to perform a real-time valuation of the endpoint device 130 in order to determine the amount of money based on the value of the endpoint device 130. When the endpoint device 130 receives the notification, the borrower may generate a money borrowing instruction at the endpoint device 130 to borrow the amount of money for the loan using the endpoint device 130 as collateral, and send the money borrowing instruction back to the platform operating server 110. At the platform operating server 110, the endpoint management application 152 may, in response to receiving the money borrowing instruction from the endpoint device 130, fund the amount of money to the borrower as a principal of a loan using the endpoint device 130 as the collateral. In certain embodiments, the borrower retains a right to use the endpoint device 130 under a condition. For example, the condition may be paying the loan payment. In other words, the condition is violated if the borrower fails to pay the loan payment. During the term of the loan, the endpoint management application 152 may keep tracking the endpoint device 130 as the collateral. For example, the endpoint management application 152 may keep monitoring a current location of the endpoint device 130 in case the borrower may violate the condition. When the borrower violates the condition, the endpoint management application 152 may disable the endpoint device 130 remotely.

In certain embodiments, the endpoint valuation system 156 may perform valuation of the endpoint device 130 by determining various different values of the endpoint device 130. For example, the endpoint valuation system 156 may determine the present value of the endpoint device 130, a past value of the endpoint device 130 as a new device, and an estimated future value of the endpoint device 130 as a used or refurbished device.

In certain embodiments, when the endpoint valuation application 156 evaluates the endpoint device 130, the endpoint valuation application 156 may consider an intrinsic value of the endpoint device 130 based on the borrower's perception of the endpoint device 130 in addition to the different types of actual and estimated values (present value, past value, and estimated future value) of the endpoint device 130. For example, studies have shown that millennials consider their smartphones more important and valuable than automobiles. In other words, if a borrower's age shows that the borrower is a millennial, and the borrower intends to use a smartphone as an endpoint device 130 to secure a loan, the smartphone may be intrinsically more valuable from the borrower's perception. Other factors that may affect the borrower's perception to the endpoint device 130 include, without being limited to, sex, occupation and economic position of the borrower, geographic location of the borrower, and other personal information of the borrower. All of these factors may be obtained from the endpoint specific data, the borrower information, or from the information obtained in the identity verification procedure. For example, the borrower's personal information such as age, sex and geographic location may be obtained from the scanned image of the state issued ID. The endpoint specific data may also include geographic location information of the endpoint device 130, which also reflects the geographic location of the borrower. In this case, the endpoint valuation application 156 may obtain perception information of the borrower based on the endpoint specific data, the borrower information, or from the information obtained in the identity verification procedure, and then determine an intrinsic value of the endpoint device 130 based on the perception information and the actual and estimated values (present value, past value, and estimated future value) of the endpoint device 130. In this way, the amount of money may be determined using the intrinsic value of the endpoint device 130.

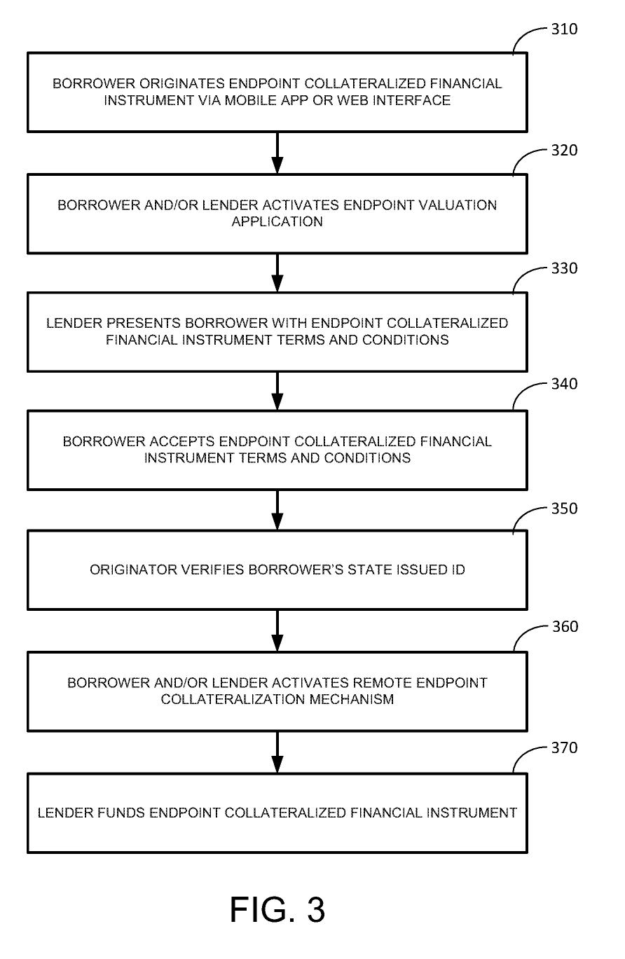

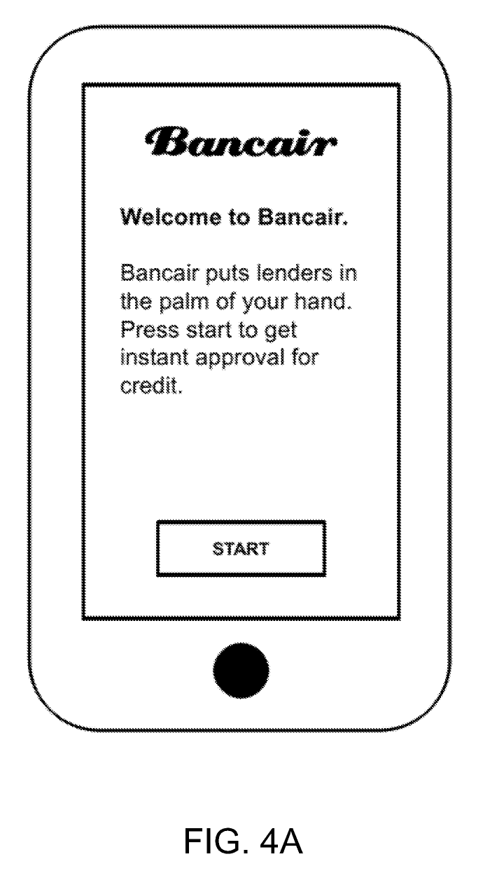

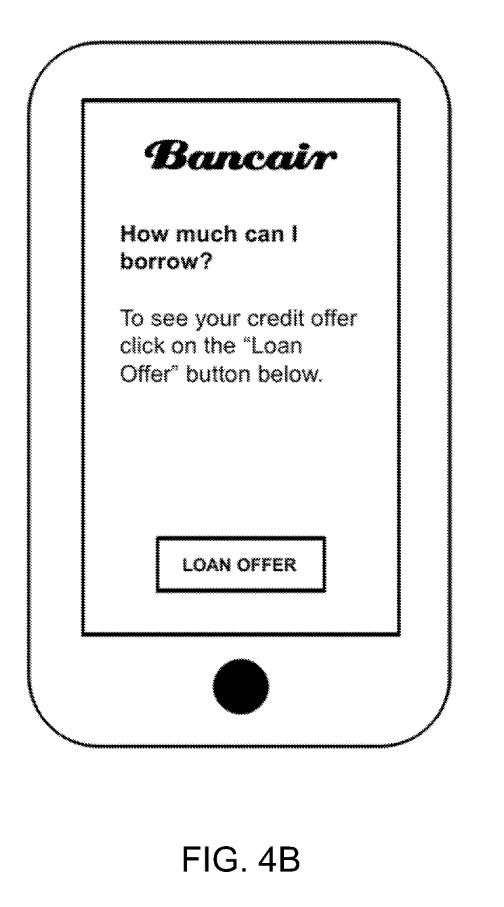

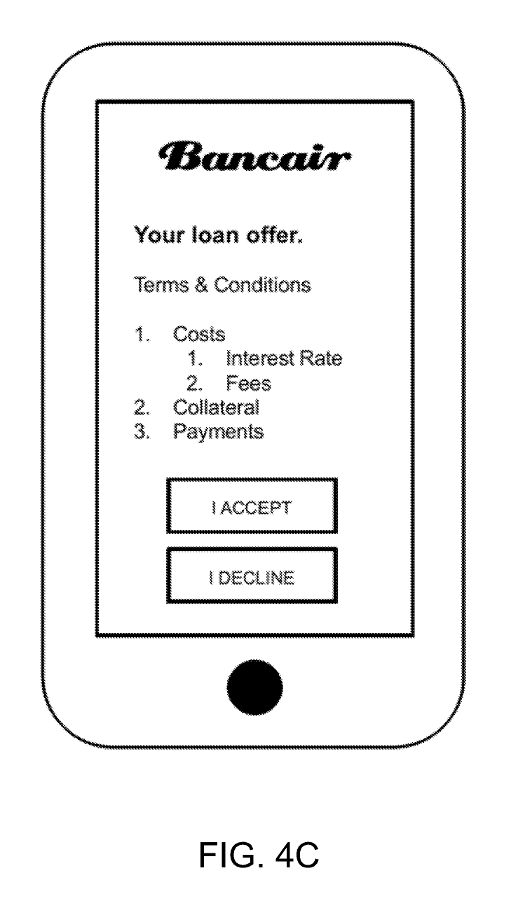

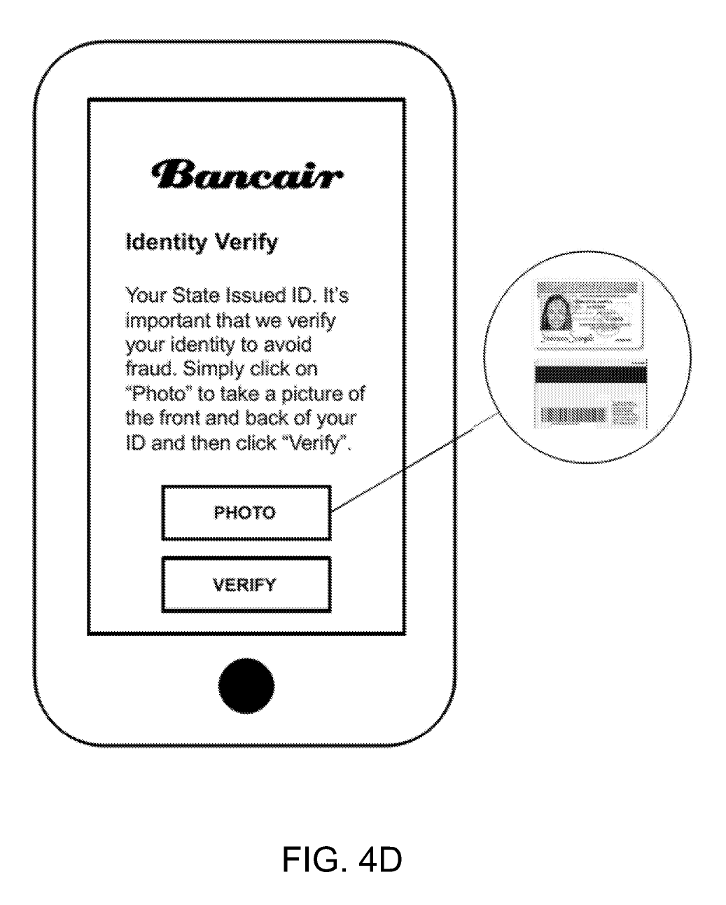

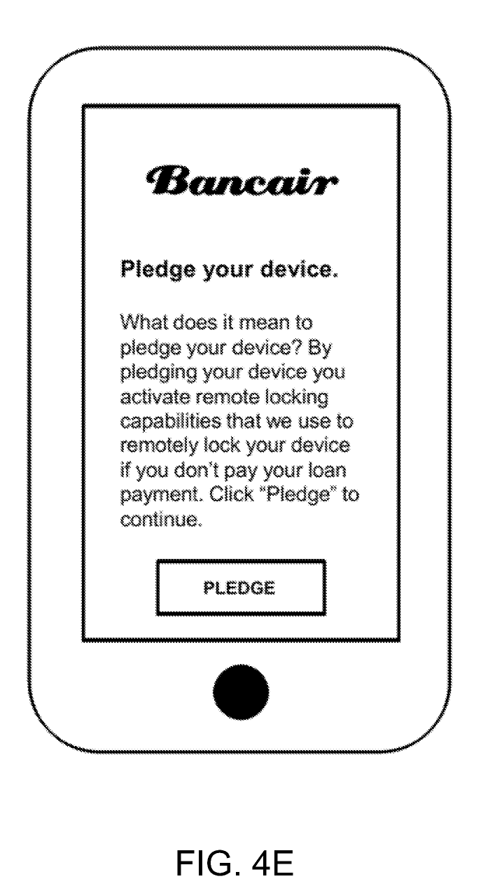

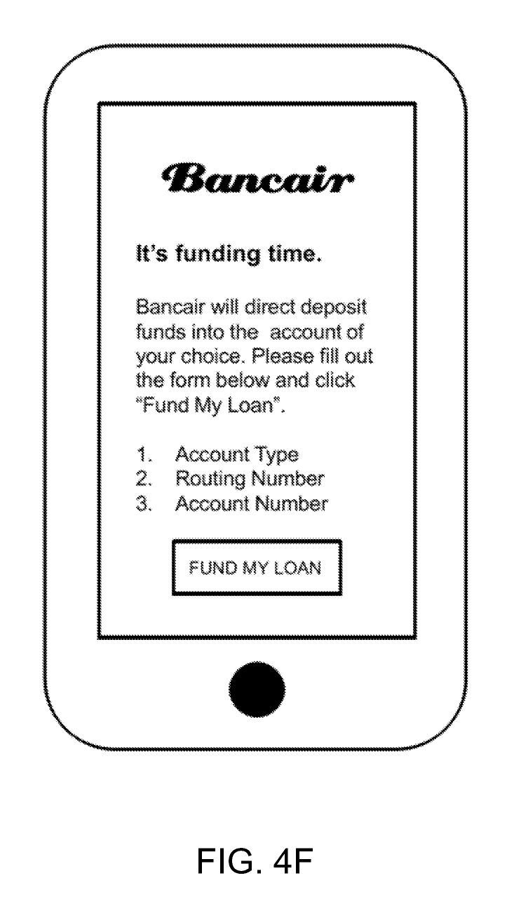

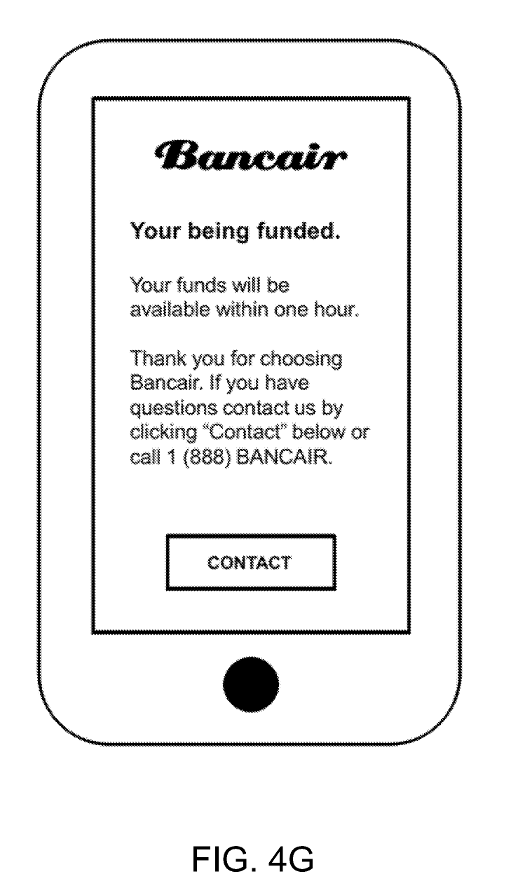

FIG. 3 shows a flowchart of operation of the system according to certain embodiments of the present invention, and FIGS. 4A to 4G schematically show screenshots of an endpoint device according to certain embodiments of the present invention. Specifically, the flowchart as shown in FIG. 3 may be performed by the system 100 as shown in FIG. 1 as an example of a borrower using an endpoint device 130 to request and obtain an endpoint collateralized financial instrument, thus obtaining a secured loan using the endpoint device 130 as the collateral. FIGS. 4A to 4G schematically show the screenshots of the endpoint device at each step of the flowchart as shown in FIG. 3. It should be particularly noted that the flowchart as shown in FIG. 3 and the screenshots as shown in FIGS. 4A to 4G merely provide examples of how the endpoint collateralized financial instrument is implemented by the system 100, and are not intended to limit the implementation or operation of the system 100.

As shown in FIG. 3, at procedure 310, a borrower may originate the operation of the system 100 to implement the endpoint collateralized financial instrument via a mobile application or a web interface on an endpoint device 130. FIG. 4A shows an example of the screenshot for the procedure 310, in which the endpoint device 130 is a mobile device (e.g., a tablet or a smartphone), and the UI of the mobile application shows the borrower a welcome message, and instructs the borrower to press the START button in order to originate the operation. Once the borrower originates the operation, the endpoint device 130 generates a corresponding request, which includes the endpoint specific data of the endpoint device 130 and borrower information identifying the borrower, and sends the request to the platform operating server 110 via the network 140. Once the platform operating server 110 receives the request, the endpoint management application 152 may determine whether the endpoint device is subject to an approval for the endpoint collateralized financial instrument based on the endpoint specific data and the borrower information. If the endpoint device 130 is not subject to the approval, the request will be denied, and the operation stops.

Assuming that the endpoint device 130 is subject to the approval, at procedure 320, the borrower and/or the lender may activate the endpoint valuation application 156 in order to determine an amount of money that the borrower may borrow using the endpoint device 130 as the collateral. Specifically, at the server side, once the endpoint valuation application 156 is activated, the endpoint valuation application 156 may determine the amount of money based on the endpoint specific data of the endpoint device 130. In certain embodiments, the endpoint valuation application 156 may evaluate the endpoint device and determine a present value (such as a fair market value or a retail price) of the endpoint device 130 based on the endpoint specific data, and then determine the amount of money based on the present value of the endpoint device 130. Once the amount of money is determined, the endpoint management application 152 may send a notification to the endpoint device 130 via the network 140 to indicate the approval for the endpoint collateralized financial instrument and the amount of money to be borrowable by the borrower. FIG. 4B shows an example of the screenshot for the procedure 320, in which the UI of the mobile application shows the borrower an instruction to view the loan offer (i.e., the amount of money). It should be noted that, in certain embodiments, the procedure 320 may be performed either by the borrower or by the lender. In other words, the endpoint valuation application 156 may be activated based on the instruction of the borrower and/or the lender.

At procedure 330, the lender presents the borrower with the terms and conditions of the endpoint collateralized instrument. Specifically, the terms and conditions may include, without being limited to, the costs (such as the interest rate and fees) of the loan, the collateral, and payment terms. FIG. 4C shows an example of the screenshot for the procedure 330, in which the UI of the mobile application shows the borrower an instruction to view the terms and conditions, and provides options for the borrower to accept or decline the loan offer under the terms and conditions. If the borrower declines the offer, the operation stops. At procedure 340, the borrower may choose to accept the offer.

Once the offer is accepted, at procedure 350, the endpoint application of the endpoint device 130 may request the borrower to present a state issued ID for identity verification purposes. FIG. 4D shows an example of the screenshot for the procedure 350, in which the UI of the mobile application shows the borrower an instruction to scan the state issued ID for identity verification purposes. It should be noted that the identity verification procedure may be performed with other mechanisms being involved, and is not limited to using the state issued ID.

At procedure 360, the endpoint application of the endpoint device 130 may request the borrower to “pledge” the endpoint device 130 in order to activate the remote endpoint collateralization mechanism. Specifically, the pledging action is to activate the remote locking capabilities on the endpoint device 130, such that the borrower retains a right to use the endpoint device under a condition, and if the borrower violates the condition, the lender may have the capabilities to remotely lock the endpoint device 130. By choosing the pledge the endpoint device 130, the endpoint device 130 generates a corresponding money borrowing instruction, and sends the money borrowing instruction back to the platform operating server 110. FIG. 4E shows an example of the screenshot for the procedure 360, in which the UI of the mobile application shows the borrower an instruction to pledge the device, and indicates that the lender may remotely lock the device if the borrower fails to pay the loan payment. In other words, the condition for the borrower to retain the right to use the endpoint device 130 is to pay the loan payment.

Once the endpoint device 130 is pledged, the platform operating server 110 may receive the money borrowing instruction. At procedure 370, the lender funds the borrower with the amount of money as a principal of the loan using the endpoint device as the collateral in response to the money borrowing instruction. FIGS. 4F and 4G shows examples of the screenshot for the procedure 370, in which the UI of the mobile application shows the borrower an instruction to provide information of the account where the funds will be directly deposited, as shown in FIG. 4F, and then shows the borrower a notification that the fund has been deposited as shown in FIG. 4G.

Several examples of the operation of the system 100 are provided as follows according to certain embodiments of the present invention. It should be appreciated that the examples are merely provided as embodiments of the present invention, without limiting the operation performed by the system 100.

In one example, a borrower uses a computing device (i.e., the endpoint device 130) and application to identify the fair market value of the endpoint device 130 and approval for an endpoint secured financial instrument equal to or less than the fair market value of the endpoint. In this instance, the borrower may or may not be required to provide a credit score. If approved, the borrower then executes an endpoint collateralized financial instrument for an amount equal to or less then the fair market value of the endpoint device 130. Thereafter the borrower receives the proceeds of the endpoint collateralized financial instrument and retains the right to use said endpoint device 130 as long as the borrower pays periodic payments required to repay the endpoint collateralized financial instrument. In this example, the borrower uses the endpoint collateralized financial instrument to secure a $340.00 loan, which is an amount equal to the fair market value of the endpoint device 130. By utilizing the endpoint collateralized financial instrument, the borrower secures the required short-term loan to pay other financial obligations. In exchange for providing the endpoint secured financial instrument, the lender receives both principal and interest payments until the endpoint collateralized financial instrument is repaid in full. Repayment may or may not have a specified term.

In yet another example, a borrower uses a computing device (i.e., the endpoint device 130) and application to identify the fair market value of an endpoint device 130 and approval for an endpoint secured financial instrument greater than the fair market value of the endpoint device 130. In this instance, the borrower may or may not be required to provide a credit score. If approved, the borrower then executes an endpoint collateralized financial instrument for an amount greater than the fair market value of the endpoint. Thereafter, the borrower receives the proceeds of the endpoint collateralized financial instrument and retains the right to use said endpoint device 130 as long as the borrower pays periodic payments required to repay the endpoint collateralized financial instrument. In this example, the borrower uses the endpoint collateralized financial instrument to secure a $578.00 loan, which is an amount equal to the retail price of the endpoint device 130. By utilizing the endpoint collateralized financial instrument, the borrower secures the required short-term loan to pay other financial obligations. In exchange for providing the endpoint secured financial instrument, the lender receives both principal and interest payments until the endpoint collateralized financial instrument is repaid in full. Repayment may or may not have a specified term.

In yet another example, a borrower may use multiple endpoint devices to secure multiple loans. For example, the borrower uses a computing device (i.e., the endpoint device 130) and application to identify the fair market value of multiple endpoint devices 130 and approval for an endpoint secured financial instrument less than, equal to or greater than the combined fair market value of the endpoint devices 130. In this instance, the borrower may or may not be required to provide a credit score. If approved, the borrower then executes an endpoint collateralized financial instrument for an amount less than, equal to or greater than the fair market value of the endpoint devices 130. Thereafter, the borrower receives the proceeds of the endpoint collateralized financial instrument and retains the right to use said endpoint devices 130 as long as the borrower pays periodic payments required to repay the endpoint collateralized financial instrument. In this example, the borrower uses the endpoint collateralized financial instrument to secure a $1,333.00 loan, which includes an amount equal to the retail price ($578.00) of one endpoint device 130, plus the fair market value ($430.00) of a second endpoint device 130, plus an amount less than fair market value ($325.00) for the third endpoint device 130. By utilizing the endpoint collateralized financial instrument, the borrower secures the required short-term loan to pay other financial obligations. In exchange for providing the endpoint secured financial instrument, the lender receives both principal and interest payments until the endpoint collateralized financial instrument is repaid in full. Repayment may or may not have a specified term.

In each of the examples, the endpoint collateralized financial instrument works in conjunction with at least one endpoint device 130, at least one endpoint storage device, at least one endpoint computing device, at least one endpoint application and at least one interface for an endpoint collateralized financial instrument to store or access endpoint specific data, which is transmitted across an endpoint collateralized financial instrument network, enabling the utilization of an endpoint collateralized financial instrument to secure a loan.

It should be particularly noted that, although the borrowers in the examples use the endpoint collateralized financial instrument to obtain secured loans, the implementation of the endpoint collateralized financial instrument is not limited to the secured loan, and other forms of credit products may also be implemented by the endpoint collateralized financial instrument. For example, the endpoint collateralized financial instrument may be used by a credit card holder to increase the credit limit of the credit card using the endpoint device 110 as the collateral.

In yet another aspect, the present disclosure relates to a non-transitory computer readable medium storing computer executable code. In certain embodiments, the computer executable code may be at least a part of the software applications stored in the platform operating server 110 as described above. In certain embodiments, the non-transitory computer readable medium may include, but not limited to, the storage device 116 of the platform operating server 110 as described above, or any other storage media of the platform operating server 110.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present invention pertains without departing from its spirit and scope. For example, multiple probes may be utilized at the same time to practice the present invention. Accordingly, the scope of the present invention is defined by the appended claims rather than the foregoing description and the exemplary embodiments described therein.

1. A system for implementing an endpoint collateralized financial instrument, comprising:
a computing device functioning as a server, comprising a processor and a storage device storing computer executable code; and
an endpoint device communicatively connected to the computing device via a network and functioning as an endpoint;
wherein the computer executable code, when executed at the processor, is configured to:
receive a request from the endpoint device, wherein the request comprises endpoint specific data of the endpoint device and borrower information identifying a user of the endpoint device as a borrower;
determine whether the endpoint device is subject to an approval for the endpoint collateralized financial instrument based on the endpoint specific data and the borrower information;
when the endpoint device is subject to the approval, determine an amount of money based on the endpoint specific data, and send a notification to the endpoint device via the network to indicate the approval for the endpoint collateralized financial instrument and the amount of money to be borrowable by the borrower;
in response to receiving a money borrowing instruction from the endpoint device for the amount of money, fund the amount of money to the borrower as a principal of a loan or a credit product using the endpoint device as collateral, wherein the borrower retains a right to use the endpoint device under a condition; and
disable the endpoint device when the borrower violates the condition,
wherein when the endpoint device receives the notification, the borrower is capable of generating the money borrowing instruction at the endpoint device to borrow the amount of money for the loan or the credit product using the endpoint device as the collateral.

2. The system of claim 1, wherein the endpoint device is a smartphone, a smartwatch, a tablet, a laptop computer, a desktop computer, a point of sale (POS) terminal, an internet-enabled television, an internet-enabled motor vehicle, or a specialized internet-enabled device.

3. The system of claim 1, wherein the endpoint specific data comprises:
manufacturer data of the endpoint device;
type of the endpoint device;
a present value of the endpoint device;
operating system information of the endpoint device;
geographic location data of the endpoint device;
diagnostic data of the endpoint device; and
real-time transaction data specific to sales of the endpoint device.

4. The system of claim 3, wherein the present value of the endpoint device is a fair market value or a retail price of the endpoint device.

5. The system of claim 3, wherein the computer executable code, when executed at the processor, is configured to determine whether the endpoint device is subject to the approval based on the type of the endpoint device and the geographic location data of the endpoint device.

6. The system of claim 3, wherein the computer executable code comprises:
an endpoint management application, configured to manage the endpoint device;
an endpoint transaction analyzer, configured to perform a real-time analysis of the real-time transaction data specific to sales of the endpoint device; and
an endpoint valuation system, configured to perform valuation of the endpoint device.

7. The system of claim 6, wherein the computer executable code, when executed at the processor, is configured to determine whether the endpoint device is subject to the approval based on the real-time transaction data specific to sales of the endpoint device.

8. The system of claim 6, wherein the endpoint valuation system is configured to perform valuation of the endpoint device by:
determining the present value of the endpoint device;
determining a past value of the endpoint device as a new device; and
determining an estimated future value of the endpoint device as a used or refurbished device.

9. The system of claim 8, wherein the endpoint valuation system is further configured to perform valuation of the endpoint device by:
obtaining perception information of the borrower based on the endpoint specific data and the borrower information; and
determining an intrinsic value of the endpoint device based on the perception information and the present value, the past value and the estimated future value of the endpoint device.

10. The system of claim 9, wherein the computer executable code, when executed at the processor, is configured to determine the amount of money by:
evaluating, by the endpoint valuation system, the endpoint device and determining the intrinsic value of the endpoint device; and
determining the amount of money based on the intrinsic value of the endpoint device.

11. The system of claim 1, wherein the computer executable code, when executed at the processor, is further configured to monitor a current location of the endpoint device as the collateral.

12. The system of claim 1, wherein the condition comprises:
the borrower repaying payments of the loan or the credit product.

13. A method for implementing an endpoint collateralized financial instrument, comprising:
receiving, at a computing device, a request from an endpoint device communicatively connected to the computing device via a network, wherein the computing device functions as a server and the endpoint device functions as an endpoint, and the request comprises endpoint specific data of the endpoint device and borrower information identifying a user of the endpoint device as a borrower;
determining, by the computing device, whether the endpoint device is subject to an approval for the endpoint collateralized financial instrument based on the endpoint specific data and the borrower information;
when the endpoint device is subject to the approval, determining, by the computing device, an amount of money borrowable by the borrower based on the endpoint specific data, and issuing a notification to the endpoint device via the network to indicate the approval for the endpoint collateralized financial instrument;
in response to receiving a money borrowing instruction from the endpoint device for the amount of money, funding, by the computing device, the amount of money to the borrower as a principal of a loan or a credit product using the endpoint device as collateral, wherein the borrower retains a right to use the endpoint device under a condition; and
disabling, by the computing device, the endpoint device when the borrower violates the condition,
wherein when the endpoint device receives the notification, the borrower is capable of generating the money borrowing instruction at the endpoint device to borrow the amount of money for the loan or the credit product using the endpoint device as the collateral.

14. The method of claim 13, wherein the endpoint device is a smartphone, a smartwatch, a tablet, a laptop computer, a desktop computer, a point of sale (POS) terminal, an internet-enabled television, an internet-enabled motor vehicle, or a specialized internet-enabled device.

15. The method of claim 13, wherein the endpoint specific data comprises:
manufacturer data of the endpoint device;
type of the endpoint device;
a present value of the endpoint device;
operating system information of the endpoint device;
geographic location data of the endpoint device;
diagnostic data of the endpoint device; and
real-time transaction data specific to sales of the endpoint device.

16. The method of claim 15, wherein the amount of money is determined by:
evaluating the endpoint device and determining an intrinsic value of the endpoint device by:
determining the present value of the endpoint device;
determining a past value of the endpoint device as a new device;
determining an estimated future value of the endpoint device as a used or refurbished device;
obtaining perception information of the borrower based on the endpoint specific data and the borrower information; and
determining the intrinsic value of the endpoint device based on the perception information and the present value, the past value and the estimated future value of the endpoint device; and
determining the amount of money based on the present value of the endpoint device.

17. The method of claim 13, further comprising:
monitoring a current location of the endpoint device as the collateral.

18. The method of claim 13, wherein the condition comprises:
the borrower repaying payments of the loan or the credit product.

19. A non-transitory computer readable medium storing computer executable code, wherein the computer executable code, when executed at a processor of a computing device, is configured to:
receive a request from an endpoint device communicatively connected to the computing device via a network, wherein the computing device functions as a server and the endpoint device functions as an endpoint, and the request comprises endpoint specific data of the endpoint device and borrower information identifying a user of the endpoint device as a borrower;
determine whether the endpoint device is subject to an approval for the endpoint collateralized financial instrument based on the endpoint specific data and the borrower information;
when the endpoint device is subject to the approval, determine an amount of money borrowable by the borrower based on the endpoint specific data, and issuing a notification to the endpoint device via the network to indicate the approval for the endpoint collateralized financial instrument;
in response to receiving a money borrowing instruction from the endpoint device for the amount of money, fund the amount of money to the borrower as a principal of a loan or a credit product using the endpoint device as collateral, wherein the borrower retains a right to use the endpoint device under a condition; and
disable the endpoint device when the borrower violates the condition,
wherein when the endpoint device receives the notification, the borrower is capable of generating the money borrowing instruction at the endpoint device to borrow the amount of money for the loan or a credit product using the endpoint device as the collateral.

20. The non-transitory computer readable medium of claim 19, wherein the endpoint device is a smartphone, a smartwatch, a tablet, a laptop computer, a desktop computer, a point of sale (POS) terminal, an internet-enabled television, an internet-enabled motor vehicle, or a specialized internet-enabled device.
